(19) United States
(12) Patent Application Publication
(10) Pub. No.: US 2014/0010437 A1
(43) Pub. Date: Jan. 9, 2014

(54) COMPOUND OBJECT SEPARATION

(71) Applicants: Ram C. Naidu, Newton, MA (US); Andrew Litvin, Wakefield, MA (US); Sergey B. Simanovsky, Brookline, MA (US)

(72) Inventors: Ram C. Naidu, Newton, MA (US); Andrew Litvin, Wakefield, MA (US); Sergey B. Simanovsky, Brookline, MA (US)

(21) Appl. No.: 14/006,381

(22) PCT Filed: Mar. 22, 2011
(86) PCT No.: PCT/US11/29315

§ 371 Date: Sep. 20, 2013

(51) Int. Cl. G06T 7/00

(52) U.S. Cl. CPC G06T 7/0079
USPC 382/154

(57) ABSTRACT

Representations of an object 110 in an image generated by an imaging apparatus 100 can comprise one or more potential compound objects 500, where a compound object comprises two or more separate sub-objects. Compound objects can negatively affect the quality of object visualization and/or make identifying threat objects more difficult, for example. Accordingly, as provided herein, a representation of a potential compound object 500 can be examined for separation into sub-objects. To do so, three-dimensional image data of a potential compound object 500 is projected to generate one or more Eigen projections 504, and segmentation is performed on the two-dimensional Eigen projection(s) to identify sub-objects. Once sub-objects are identified, the segmented Eigen projection(s) 900 is back-projected into three-dimensional space 1104 for further processing, for example.

### BACKGROUND

The present application relates to the field of x-ray imaging. It finds particular application with computed tomography (CT) security and industrial scanners, but it also relates to other applications (e.g., such as medical applications) where identifying sub-objects of a compound object would be useful.

Security at airports and in other travel related areas is an important issue given today's sociopolitical climate, as well as other considerations. One technique used to promote travel safety is baggage inspection. Often, an x-ray imaging apparatus is utilized to facilitate baggage screening. For example, a CT scanner may be used to provide security personnel with two and/or three dimensional views of objects. After viewing images provided by the imaging apparatus, security personnel may make a decision as to whether the baggage is safe to pass through the security checkpoint or if further (hands-on) inspection is warranted.

Current screening techniques and systems can utilize automated object recognition in images from an imaging apparatus, for example, when screening for potential threat objects inside luggage. These systems can extract an object from an image, and compute properties of the extracted object. Properties of the examined object can then be used for discriminating an object by comparing the object's properties (e.g., density, shape, z-effective, etc.) with known properties of threat items, non-threat items, or both classes of items. It can be appreciated that an ability to discriminate potential threats may be reduced if an extracted object comprises multiple distinct physical objects. Such an extracted object is referred to as a compound object.

A compound object can be made up of two or more distinct items (e.g., referred to herein as sub-objects). For example, if two items are lying side by side and/or touching each other, a security system may extract the two items as a single compound object. Because the compound object actually comprises two separate objects, however, properties of the compound object may not be able to be effectively compared with those of known threat and/or non-threat items. As such, for example, luggage containing a compound object may unnecessarily be flagged for additional (hands-on) inspection because the properties of the compound object resemble properties of a known threat object. This can, among other things, reduce the throughput at a security checkpoint. Alternatively, a compound object that should be inspected further may not be so identified because properties of a potential threat object in the compound object are “contaminated” or combined with properties of one or more other (non-threat) objects in the compound object, and these “contaminated” properties (of the compound object) might more closely resemble those of a non-threat object than those of a threat object, or vice versa.

Compound object splitting can be applied to objects in an attempt to improve threat item detection, and thereby increase the throughput and effectiveness at a security check-point. Compound object splitting essentially identifies potential compound objects and splits them into sub-objects. Compound object splitting involving components with different densities and/or z-effectives (e.g., where the scanner is a dual-energy scanner) may be performed using a histogram-based compound object splitting algorithm. Other techniques include using surface volume erosion to split objects. However, using erosion as a stand-alone technique to split compound objects can lead to undesirable effects. For example, erosion can reduce a mass of an object, indiscriminately split objects that are not compound, and/or fail to split some compound objects. Additionally, in these techniques, erosion and splitting may be applied universally, without regard to whether an object is a potential compound object at all.

### SUMMARY

Aspects of the present application address the above matters, and others. According to one aspect, a method for separating a three-dimensional representation of compound object into sub-objects is provided. The method comprises using an Eigen projection representative of the compound object and generated from the three-dimensional representation of the compound object generated by an x-ray examination to yield a three-dimensional representation indicative of one or more sub-objects of the compound object.

According to another aspect, a system for compound object separation in image data is provided. The system comprises an Eigen projection component configured to generate an Eigen projection from a three-dimensional representation of a compound object. The system also comprises a segmentation component configured to generate a segmented Eigen projection of the compound object by segmenting pixels of the Eigen projection representative of a first sub-object of the compound object and pixels of the Eigen projection representative of a second sub-object of the compound object if there is a second sub-object. The system further comprises a back-projection component configured to relabel a voxel of the three-dimensional representation of the compound object according to a label assigned to a corresponding pixel in the segmented Eigen projection to generate a three-dimensional representation indicative of one or more sub-objects of the compound object.

According to another aspect, a computer readable storage device comprising computer executable instructions that when executed via a microprocessor perform a method is provided. The method comprises generating an Eigen projection of three-dimensional image data indicative of a compound object by projecting the three-dimensional image data onto a plane normal to a principal axis of the three-dimensional image data. The method also comprises eroding the Eigen projection using an adaptive erosion technique to generate an eroded Eigen projection and segmenting the eroded Eigen projection to generate a segmented Eigen projection indicative of one or more sub-objects of the compound object. The method further comprises projecting the segmented Eigen projection into three-dimensional image data indicative of one or more sub-objects.

Those of ordinary skill in the art will appreciate still other aspects of the present invention upon reading and understanding the appended description.

### DESCRIPTION OF THE DRAWINGS

FIG. 1 is a schematic block diagram illustrating an example scanner.

FIG. 2 is a component block diagram illustrating details of one or more components of an environment wherein compound object splitting of objects in an image may be implemented as provided herein.

FIG. 3 is a component block diagram illustrating details of one or more components of an environment wherein compound object splitting of objects in an image may be implemented as provided herein.

FIG. 4 is a flow chart diagram of an example method for compound object splitting.

FIG. 5 is a graphical representation of three-dimensional image data of a compound object being converted into a two-dimensional Eigen projection.

FIG. 6 illustrates a portion of a two-dimensional Eigen projection.

FIG. 7 illustrates a portion of a two-dimensional Eigen projection after the projection has been eroded.

FIG. 8 is a graphical representation of a two-dimensional Eigen projection that has been eroded.

FIG. 9 is a graphical representation of a two-dimensional, segmented Eigen projection.

FIG. 10 is a graphical representation of a two-dimensional, segmented Eigen projection that has been pruned.

FIG. 11 is a graphical representation of a two-dimensional, segmented Eigen projection being back-projected into three-dimensional image space.

FIG. 12 is an illustration of an example computer-readable medium comprising processor-executable instructions configured to embody one or more of the provisions set forth herein.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

One or more systems and/or techniques for separating a compound object representation into sub-objects in image data generated by subjecting one or more objects to imaging using an imaging apparatus (e.g., a computed tomography (CT) image of a piece of luggage under inspection at a security station at an airport) are provided herein. More specifically, techniques for separating three-dimension image data (e.g., a three-dimensional representation) of an object by projecting the three-dimensional image data to generate an Eigen projection, eroding one or more pixels of the Eigen projection to separate pixels associated with a first sub-object from pixels associated with a second sub-object (e.g., assuming there are two or more sub-objects), and back-projecting the Eigen projection into three-dimensional image data indicative of, representative of, etc. one or more sub-objects are provided. Thus, more generally, techniques and systems for splitting image date representative of compound objects into data representative of distinct sub-objects are provided.

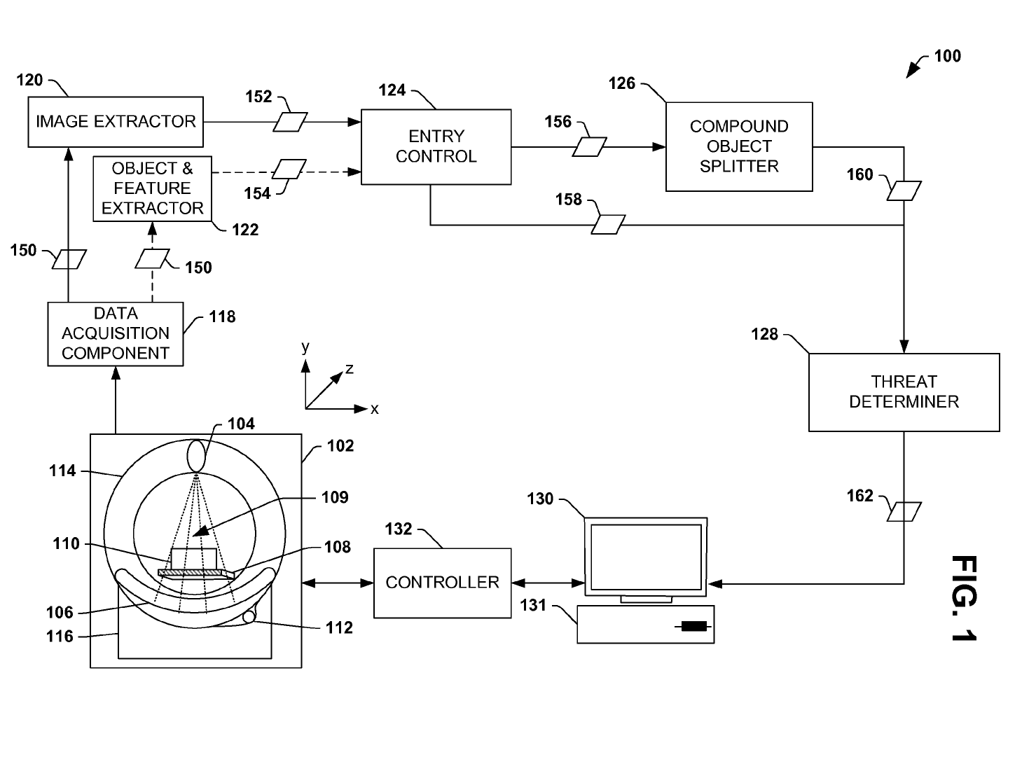

FIG. 1 is an illustration of an example environment 100 in which a system may be employed for identifying potential threat containing objects, from a class of objects, inside a container that has been subjected to imaging using a x-ray imaging apparatus 102 (e.g., a CT scanner). Data generated from the x-ray examination may yield one or more images of an object(s) 110 under examination that may be displayed on a monitor 130, for example, such as for viewing by a human user (e.g., radiologist, security personnel, etc.). Such a system may be used to diagnose medical conditions (e.g., broken bones) in a human patient at a medical center or in an animal at a veterinary clinic, and/or to identify objects of interest (e.g., potential threat objects, banned objects, etc.) associated with (e.g., comprising, comprised within, etc.) an object(s) 110 (e.g., luggage) under examination at a security checkpoint, for example. In another embodiment, no image is generated, but, depending at least in part on an acquisition modality, a density (or some other physico-chemical property) of respective objects (or aspects or parts thereof) can be identified and compared with a list of densities, z-effectives, etc. associated with predetermined items (e.g., banned items) to determine if the object(s) 110 potentially comprises one or more of the predetermined items.

It will be appreciated that while a single energy CT scanner is at times described herein, the instant application is not intended to be so limited. That is, to the extent possible, the instant application, including the scope of the claimed subject matter, is intended to be applicable to other systems as well (e.g., multi-energy CT scanners). Moreover, the techniques and/or systems described herein are not intended to be limited to a CT application, and may be used in other applications where a three-dimension representation(s) of an object(s) is yielded from an examination of the object(s). It can also be appreciated that the example environment 100 merely illustrates an example schematic and is not intended to be interpreted as necessarily specifying the orientation/position of the components described herein. For example, a data acquisition component 118 as illustrated in FIG. 1, may be part of a rotating gantry 114 portion of the examination apparatus 102, or may be part of a detector array 106 of the examination apparatus 102.

In the example environment 100, the examination apparatus 102 can be configured to examine one or more objects 110 (e.g., a human patient, a series of suitcases at an airport, lumber at a lumber mill, etc.), and may comprise a rotating gantry portion 114 and a stationary portion 116. During an examination of the object(s) 110, the object(s) 110 can be placed on a support article 108, such as a bed or conveyor belt, that is selectively positioned in an examination region 109 (e.g., a hollow bore in the rotating gantry portion 114), and the rotating gantry portion 114 can be rotated about the object(s) 110 by a rotator 112 (e.g., motor, drive shaft, chain, etc.).

The rotating gantry portion 114 may surround a portion of the examination region 109 and comprises a radiation source 104 (e.g., an ionizing or non-ionizing radiation source) and a detector array 106 that is mounted on a substantially diametrically opposite side of the rotating gantry 114 relative to the radiation source 104.

During an examination of the object(s) 110, the radiation source 104 emits radiation towards the object(s) 110 under examination while the rotating gantry portion 114 (including the radiation source 104 and/or the detector array 106) rotates about the object(s) 110. Generally, in a CT scanner, the radiation is emitted substantially continuously during the examination. However, in some CT scanners and/or in other x-ray imaging devices (e.g., pulsed radiographic systems), the radiation may be pulsed or otherwise intermittently applied during the examination.

As the radiation traverses the object(s) 110, the radiation may be attenuated differently by different parts of the object(s) 110. Because different parts attenuate the radiation differently, an image may be produced based upon the attenuation, or rather indirectly from it based on the variations in the number of radiation photons that are detected by the detector array 106. For example, more dense aspects of the object(s) 110, such as a bone or metal plate, for example, may attenuate more of the radiation (e.g., causing fewer radiation photons to strike the detector array 106) than less dense materials, such as skin or clothing.

In some embodiments, while the object(s) 110 is being examined, the object(s) 110 may be translated along an axis traveling in the z-dimension (e.g., into and out of the page if, as illustrated, the rotating gantry 114 is configured to rotate in an x, y plane). In this way, an object 110 that has a z-dimension greater than the z-dimension of the radiation traversing the object 110 may be examined more quickly (relative to a step-and-shoot scanning approach). It will be appreciated that if the object(s) 110 is being translated (e.g., in the z direction) during an examination while the rotating gantry 114 is rotating (e.g., in the x, y plane), the examination may be referred to as a helical or spiral scan.

Radiation that impinges the detector array 106 generally creates an electric charge(s) (e.g., either directly or indirectly) that may be detected by electronics of the detector array 106 that are configured to detect/measure the electric charge (e.g., such as by a thin-film transistor array, complementary metal-oxide-semiconductor array, etc.). The electronics are further configured to generate a signal proportional to the amount of electric charge detected, and such signals are fed to a data acquisition component 118 (e.g., which may (or may not) be integral with the examination apparatus 102 or with the detector array 106). Because the amount of electric charge detected by the detector array 106 is directly related to the number of detected radiation photons, the output is indicative of the attenuation of the radiation as it traversed the object(s) 110.

As an example, a computed tomography (CT) security scanner 102 that comprises an x-ray source 104, such as an x-ray tube, can generate a fan, cone, wedge, or other shaped beam of x-ray radiation that traverses one or more objects 110, such as suitcases, in an examination region 109. In this example, the x-rays are emitted by the source 104, traverse the examination region 109 that contains the object(s) 110 to be scanned, and are detected by an x-ray detector 106 across from the x-ray source 104. Further, a rotator 112, such as a gantry motor drive attached to the scanner, can be used to rotate the x-ray source 104 and detector 106 around the object(s) 110, for example. In this way, x-ray projections from a variety of perspectives, or views, of the suitcase can be collected, for example, creating a set of x-ray projections for the object(s). While illustrated with the x-ray source 104 and detector 106 rotating around an object(s) 110, in another example, the radiation source 104 and detector 106 may remain substantially stationary while the object(s) 110 is rotated. In another embodiment, merely one of the radiation source 104 and the detector 106 may be rotated about the object(s) 110. In such an embodiment, the object(s) 110 may be rotated or not rotated.

The data acquisition component 118 is operably coupled to the examination apparatus 102 and is typically configured to collect information and/or data from the detector array 106, and may be used to compile the collected data into projection space data 150 for an object 110. As an example, x-ray projections may be acquired at each of a plurality of angular positions with respect to the object 110. Further, as the object(s) 110 is conveyed from an upstream portion of the object scanning apparatus 102 to a downstream portion (e.g., conveying objects parallel to the rotational axis of the scanning array (into and out of the page)), the plurality of angular position x-ray projections may be acquired at a plurality of points along the axis of rotation with respect to the object(s) 110. In one embodiment, the plurality of angular positions may comprise an X and Y axis with respect to the object(s) 110 being examined, while the rotational axis may comprise a Z axis with respect to the object(s) 110 being scanned. In this way, volumetric data (e.g., which may be converted into three dimensional image space) of the object(s) 110 under examination may be acquired.

In the example environment 100, an image extractor 120 is coupled to the data acquisition component 118, and is configured to receive the data 150 from the data acquisition component 118 and generate three-dimensional image data 152 (e.g., also referred to herein as a three-dimensional representation) indicative of and/or representative of the examined object(s) 110 using a suitable analytical, iterative, and/or other reconstruction technique (e.g., back-projection from projection space to image space, tomosynthesis reconstruction, etc.).

In one embodiment, the three-dimensional image data 152 for a suitcase, for example, may ultimately be displayed on a monitor 130 of a workstation 131 (e.g., desktop or laptop computer) for human observation. In this embodiment, an operator may isolate and manipulate the image, for example, rotating and viewing the suitcase from a variety of angles, zoom levels, and positions.

It will be appreciated that, while the example environment 100 utilizes the image extractor 120 to extract three-dimensional image data 152 from the data 150 generated by the data acquisition component 118, for example, for a suitcase being scanned, the techniques and systems, described herein, are not limited to this embodiment. In another embodiment, for example, three-dimensional image data 152 may be generated by an imaging apparatus that is not coupled to the system. In this example, the three-dimensional image data 152 may be stored onto an electronic storage device (e.g., a CD-ROM, hard-drive, flash memory) and delivered to the system electronically, for example.

In the example environment 100, in one embodiment, an object and feature extractor 122 may receive the data 150 from the data acquisition component 118, for example, in order to extract objects and features 154 from one or more items comprised within the examined object(s) 110 (e.g., a carry-on luggage containing items). It will be appreciated that the systems, described herein, are not limited to having an object and feature extractor 122 at a location in the example environment 100. For example, the object and feature extractor 122 may be a component of the image extractor 120, whereby three-dimensional image data 152 and object features 154 are both sent from the image extractor 120. In another example, the object and feature extractor 122 may be disposed after the image extractor 120 and may extract object features 154 from the three-dimensional image data 152. Those skilled in the art may devise alternative arrangements for supplying three-dimensional image data 152 and object features 154 to the example system.

In the example environment 100, an entry control 124 may receive three-dimensional image data 152 and object features 154 for the one or more examined objects 110. The entry control 124 can be configured to identify a potential compound object in the three-dimensional image data 152 based on an object's features. In one embodiment, the entry control 124 can be utilized to select objects that may be compound objects 156 for processing by a compound object splitter 126. In one example, object features 154 (e.g., properties of an object in an image, such as an Eigen-box fill ratio) can be computed prior to the entry control 120 and compared with pre-determined features for compound objects (e.g., features extracted from known compound objects during training of a system) to determine whether the one or more objects are compound objects. In another example, the entry control 124 calculates the density of a potential compound object and a standard deviation of the density. If the standard deviation is outside a predetermined range, the entry control 124 may identify the object as a potential compound object. In one example, image data 158 representative of objects that are not determined to be potential compound objects by the entry control 124 may not be sent through the compound object splitter 126 (e.g., and may be directly transmitted to a threat determiner 128 for further analysis).

In the example environment 100, the compound object splitter 126 receives three-dimensional image data 156 indicative of a potential compound object from the entry control 120. The compound object splitter 126 can be configured to identify sub-objects from the potential compound object by projecting the three-dimensional image data to generate one or more two-dimensional Eigen projections and recording a correspondence between the three-dimensional image data (e.g., voxel data) and the two-dimensional Eigen projection(s) (e.g., pixel data), for example. Once projected, one or more pixels indicative of the compound object in a two-dimensional Eigen projection may be eroded. Pixels that are not eroded may be segmented to generate a two-dimensional segmented Eigen projection indicative of one or more sub-objects of the potential compound object 156. It will be appreciated that where the potential compound object 156 is actually a single object (and not a plurality of objects), the two-dimensional segmented projection may be indicative of a sub-object that substantially resembles the potential compound object 156. The two-dimensional segmented Eigen projection may then be projected from two-dimensional space to three-dimensional image space indicative of the sub-objects 160 utilizing the correspondence between the three-dimensional image data and the two-dimensional Eigen data, for example.

In the example environment 100, a threat determiner 128 can be configured to receive image data for an object, which may comprise image data indicative of sub-objects 160 and/or image data 158 that was determined by the entry control 124 to merely be representative of a single item. The threat determiner 128 can also be configured to compare the image data to one or more pre-determined thresholds, corresponding to one or more potential threat objects. It will be appreciated that the systems and techniques provided herein are not limited to utilizing a threat determiner 128, and may be utilized for separating compound objects without a threat determiner 128. For example, image data for an object may be sent to a workstation 131 wherein an image of the object 110(s) under examination 110 may be displayed for human observation.

Information concerning whether an examined object is potentially threat containing and/or information concerning sub-objects 162 can be sent to a workstation 131 in the example environment 100, for example, comprising a display 130 that can be viewed by security personal at a luggage screening checkpoint. In this way, in this example, real-time information can be retrieved for objects subjected to examination by a security scanner 102.

In the example environment 100, a controller 132 is operably coupled to the workstation 131. The controller 132 receives commands from the workstation 131 and generates instructions for the object examination apparatus 102 indicative of operations to be performed. For example, a user may want to rescan the object(s) 110 using a different dose or energy of radiation and the controller 132 may issue an instruction instructing the radiation source 104 to emit the desired dose or energy of radiation.

It will be appreciated that while reference is made herein to computed tomography scanners, to the extent practicable, other x-ray systems that are configured to yielded three-dimensional image data and/or volumetric data indicative of an object under examination are also contemplated herein. Moreover, the block diagram merely illustrates example components of an x-ray system and is not intended to limit the scope of the claims and/or the instant disclosure. For example, in another embodiment, the x-ray system does not comprise a threat determiner and the image data yielded from the entry control 124 and/or the compound object splitter 126 is merely transmitted to the workstation 131. In another example, the data acquisition component 118 may be part of the detector array 106 of the examination apparatus 102. Thus, to the extent possible, some components of the illustrated x-ray system may be removed or substituted with other components, some components of the illustrated x-ray system may be combined with other components, and/or additional components may be added to the x-ray system described herein, for example.

FIG. 2 is a component block diagram illustrating one embodiment 200 of an entry control 124, which can be configured to identify a potential compound object based on an object's features. The entry control 124 can comprise a feature threshold comparison component 202, which can be configured to compare the respective one or more feature values 154 to a corresponding feature threshold (e.g., stored in a database (not shown)).

In one embodiment, image data 152 for an object in question can be sent to the entry control 124, along with one or more corresponding feature values 154. In this embodiment, feature values 154 can include, but not be limited to, an object's shape properties, such as an Eigen-box fill ratio (EBFR) for the object in question. As an example, objects having a large EBFR typically comprise a more uniform shape; while objects having a small EBFR typically demonstrate irregularities in shape. In this embodiment, the feature threshold comparison component 202 can compare one or more object feature values with a threshold value for that object feature, to determine which of the one or more features indicate a compound object for the object in question. In another embodiment, the feature values 154 can include properties related to the average density of the object and/or the standard deviation of densities of portions of the object, for example. In such an example, the feature threshold comparison component 202 may compare the standard deviation of the densities to a threshold value to determine whether a compound object may be present.

In the example embodiment 200, the entry control 124 can also comprise an entry decision component 204, which can be configured to identify a potential compound object based on results from the feature threshold comparison component 202. In one embodiment, the decision component 204 may identify a potential compound object based on a desired number of positive results for respective object features, the positive results comprising an indication of a potential compound object. As an example, in this embodiment, a desired number of positive results may be one hundred percent, which means that if one of the object features indicates a non-compound object, the object, or rather image data indicative of or representing the object, may not be sent to be separated 158. However, in this example, if the object in question has the desired number of positive results (e.g., all of them) then the image data for the potential compound object can be sent for separation 156. In another example, the decision component 204 may identify a potential compound object when the standard deviation exceeds a predefined threshold at the threshold comparison component 202.

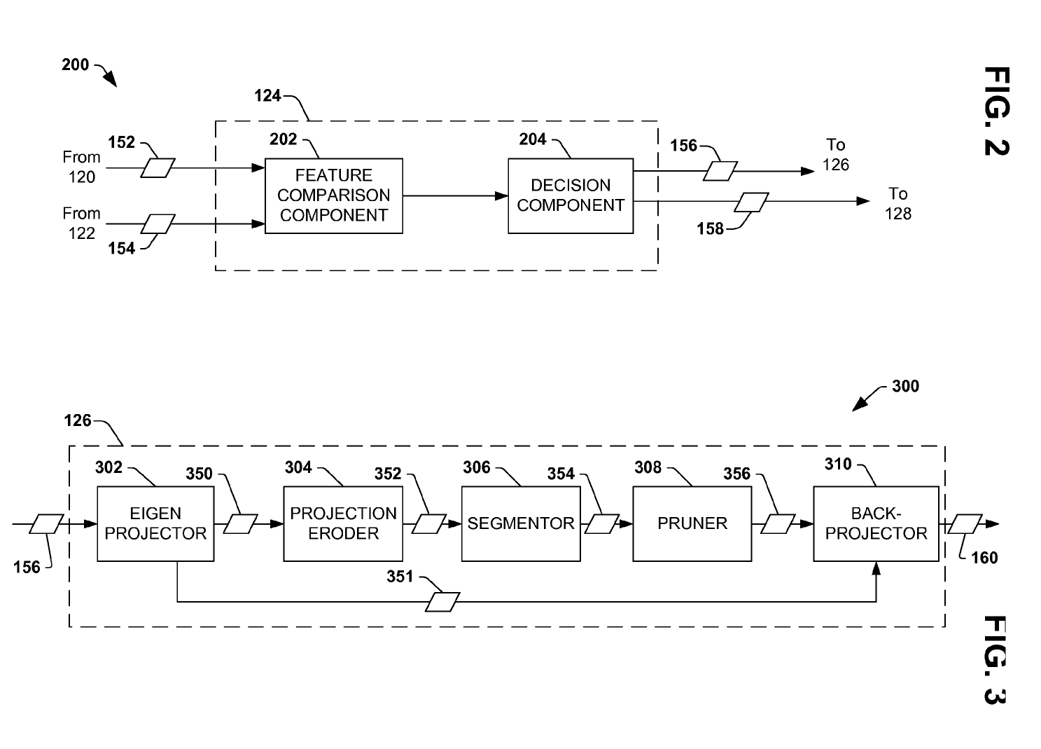

FIG. 3 is a component block diagram of one example embodiment 300 of a compound object splitter 126, which can be configured to generate three-dimensional image data 160 indicative of sub-objects from three-dimension image data 156 indicative of a potential compound object.

The example embodiment of the compound object splitter 126 comprises an Eigen projector 302 (e.g., also referred to herein as an Eigen projection component) configured to receive the three-dimensional image data 156 indicative of the potential compound object. The Eigen projector 302 is also configured to convert the three-dimensional image data 156 indicative of the potential compound object into one or more two-dimensional Eigen projections 350 indicative of the potential compound object and to record a correspondence 351 between the three-dimensional image data and the two-dimensional Eigen projection 350. That is, one or more voxels of the three-dimensional image data are recorded as being represented by, or associated with, a pixel of the two-dimensional Eigen projection 350 indicative of the potential compound object. Such a recording may be beneficial during back-projection from a two-dimensional projection to three-dimensional image space so that properties of the voxels (e.g., densities of the voxels, atomic numbers identified by the voxels, etc.) are not lost (in whole or in part) during the projection and back-projection, for example. It will be appreciated that while the Eigen projector 302 records the correspondence 351 in this embodiment, in other embodiments, another component of the compound object splitter 126 and/or other components of the example environment 100 may record the correspondence 351.

It will be appreciated to those skilled in the art that an Eigen projection is a two-dimensional representation of a three-dimensional object, where one or more two-dimensional planes associated with the projection are normal to respective principal axes of the object. While Eigen projections, Eigen vectors, Eigen values, and the like are known to those skilled in the art, Eigen vectors (e.g., principal axis) may be explained simply with regards to surface area. Generally, a first principal axis lies within a plane that causes the greatest amount of surface area of the object to be viewed (e.g., if a two-dimensional image of that plane is generated from the three-dimensional representation of the object). Because the Eigen vectors create a Cartesian coordinate system, the other two principal axes may be determined based upon the identification of the first principal axis. It will be appreciated that the orientations of the principal axes do not vary relative to the object based upon the orientation of the compound object. For example, regardless of whether a book is tilted at a 45 degree angle or at a 50 degree angle relative an examination surface (e.g., 108 in FIG. 1), the principal x-axis, for example, will have a same orientation relative to the object but may have a different orientation relative to the examination surface. That is, in such an embodiment, the principal x-axis, for example, may be tilted at an angle of 45 degrees relative to the examination surface in the first scenario and tilted at an angle of 50 degrees relative to the examination surface in the second scenario, but relative to the object, the principal x-axis may be in the same location in both scenarios. In this way, in at least one Eigen projection of the object, the amount of space lost due to the projection (e.g., the amount of space in the collapsed, third-dimension) is mitigated (e.g., minimized). In the other Eigen projections (e.g., projected normal to the other two Eigen vectors), the amount of space lost due to the projection may be greater.

A pixel in the two-dimensional Eigen projection 350 represents one or more voxels of the three-dimensional image data 156. The number of voxels that are represented by a given voxel may depend upon the number of object voxels that are “stacked” in a dimension of the three-dimensional image data 156 that is not included in the two-dimensional Eigen projection 350, or rather the number of non-empty voxels (e.g., the number of voxels representing the object) along the Eigen vector (e.g., principal axis) that is normal to the projection. For example, if at given principal x and z coordinates, three voxels are stacked in the principal y-dimension of the three-dimensional image data 156 (e.g., after the principal axes have been determined), a pixel corresponding to the given x and z coordinate may represent three voxels in the two-dimensional Eigen projection 350. Similarly, a pixel adjacent to the pixel may represent five voxels if at second x and z coordinates, five voxels are stacked in the principal y-dimension (e.g., the compound object has a larger y-dimension at the x, z coordinates of the adjacent pixel than it does at the pixel). The number of voxels represented by a pixel may be referred to herein as a “pixel value”.

In the example embodiment 300, the compound object splitter 126 further comprises a projection eroder 304 (e.g., also referred to herein as a projection erosion component) which is configured to receive the two-dimensional Eigen projection 350. The projection eroder 304 is also configured to erode the two-dimensional Eigen projection 350, and thus reveal one or more sub-objects of the potential compound object. In one example, the projection eroder 304 uses an adaptive erosion technique to erode one or more pixels of the two-dimensional manifold projection 350, and the sub-objects are revealed based upon spaces, or gaps, within the compound object. It will be appreciated that an “adaptive erosion technique” as used herein refers to a technique that adjusts criteria, or erosion thresholds, for determining which pixels to erode as a function of characteristics of one or more (neighboring) pixels. That is, the erosion threshold is not constant, but rather changes according to the properties, or characteristics of the pixels.

In one example of an adaptive erosion technique, the projection eroder 304 determines whether to erode a first pixel by comparing pixels values for pixels neighboring the first pixel to determine an erosion threshold for the first pixel. Once the erosion threshold for the first pixel is determined, the threshold is compared to respective pixel values of the neighboring pixels. If a predetermined number of respective pixel values are below the threshold, the first pixel is eroded (e.g., a value of the pixel is set to zero or some value not indicative of an object). The projection eroder 304 may repeat a similar adaptive erosion technique on a plurality of pixels to identify spaces, or divides, in the compound object. In this way, one or more portions of the compound object may be divided to reveal one or more sub-objects (e.g., each “group” of pixels corresponding to a sub-object). It will be appreciated that other adaptive techniques and/or static techniques (e.g., where the erosion threshold remains substantially constant during the erosion of a plurality of pixels) known to those skilled in the art are also contemplated herein.

The compound object splitter 126 further comprises a two-dimensional segmentation component 306 (e.g., also referred to herein as a segmentor, a segmentation component, and the like) configured to receive the eroded Eigen projection 352 from the projection eroder 304 and to segment the eroded Eigen projection 352 to generate a segmented, Eigen projection 354, for example. As an example, segmentation may include binning the pixels into bins corresponding to a respective sub-object and/or labeling pixels associated with identified sub-objects. For example, before erosion, the pixels may have been labeled with number “1”, indicative of (compound) object “1”. However, after erosion, one or more sub-objects of the (compound) object “1” may be identified, and a first group of pixels be may labeled according to a value (e.g., “1”) assigned to a first identified sub-object, a second group of pixels may be labeled according to a value (e.g., “2”) assigned to a second identified sub-object, etc. In this way, respective sub-objects may be identified as distinct objects in the image, rather than a single compound object.

In the example embodiment 300, the compound object splitter 126 further comprises a pruner 308 (e.g., also referred to herein as a pruning component) that is configured to receive the segmented, Eigen projection 354. The pruner 308 is also configured to prune pixels of the segmented Eigen projection 354 that are indicative of sub-objects that do not meet predetermined criteria (e.g., the sub-object is represented by too few pixels to be considered a threat, the mass of the sub-object is not great enough to be a threat, etc.). In one embodiment, pruning comprises relabeling pixels indicative of the sub-objects that do not meet predetermined criteria as background (e.g., labeling the pixels as “0”), or otherwise discarding the pixels. As an example, a sub-object that is represented by three pixels may be immaterial to achieving the purpose of the examination (e.g., threat detection), and the pruner 308 may discard the sub-object by altering the pixels.

The compound object splitter 126 further comprises a back-projector 310 configured to receive the pruned and segmented Eigen projection 356 and to back-project the two-dimensional Eigen projection 356 into three-dimensional image data indicative of the sub-objects 160. That is, the back-projector 310 is configured to reverse map the data from two-dimensional Eigen space into three-dimensional image space utilizing the correspondence 351 between the three-dimensional image data and the two-dimensional Eigen projection 356, for example. In this way, voxels of the three-dimensional data indicative of the potential compound object 156 may be relabeled according to the labels assigned to corresponding pixels in the two-dimensional Eigen projection 356 to generate the three-dimensional image data indicative of the sub-objects 160. For example, voxels originally labeled as indicative of compound object “1” may be relabeled; a portion of the voxels relabeled as indicative of sub-object “1” and a portion of the voxels relabeled as indicative of sub-object “2.” It will be appreciated that by relabeling the voxels of the three-dimensional data indicative of the potential compound object 156, properties of the voxels (and therefore of the object) may be retained. Stated differently, by using such a technique, at least some the properties of the object may not be lost during the projection into projection space and the back-projection into three-dimensional image space. Moreover, it will be appreciated that voxels associated with pixels that were eroded and/or pruned may be discarded or ignored (e.g., by zeroing the associated voxels and treating the data associated with the zeroed voxels as though it does not exist).

It will be appreciated that the compound object splitter 126 illustrated herein merely provides one technique for object splitting, and to the extent possible, other techniques which involve projecting three-dimensional image data into one or more two-dimensional Eigen projections, identifying objects in the Eigen projection(s), and back-projecting (or otherwise returning) to three-dimensional image space, are contemplated herein. For example, in another embodiment, the compound object splitter 126 is similarly configured to that illustrated in FIG. 3, but the pruner 308 is absent (e.g., and thus pixels and/or voxels of a sub-object(s) that may be immaterial to the examination and/or threat detection are not discarded).

The three-dimensional image data indicative of the sub-objects 160 may be displayed on a monitor of a terminal (e.g., 132 in FIG. 1) and/or transmitted to a threat determiner (e.g., 128 in FIG. 1) that is configured to identify threats according to properties of an object. It will be appreciated that because the compound object has been divided into one or more sub-objects, the threat determiner may better discern the characteristics of an object and thus may more accurately detect threats, for example.

A method may be devised for separating a compound object into sub-objects in an image generated by an imaging apparatus (e.g., an x-ray imaging system). In one embodiment, the method may be used by a threat determination system in a security checkpoint that screens passenger luggage for potential threat items. In this embodiment, an ability of a threat determination system to detect potential threats may be reduced if compound objects are introduced, as computed properties of the compound object may not be specific to a single physical object. Therefore, one may wish to separate the compound object into distinct sub-objects of which it is comprised.

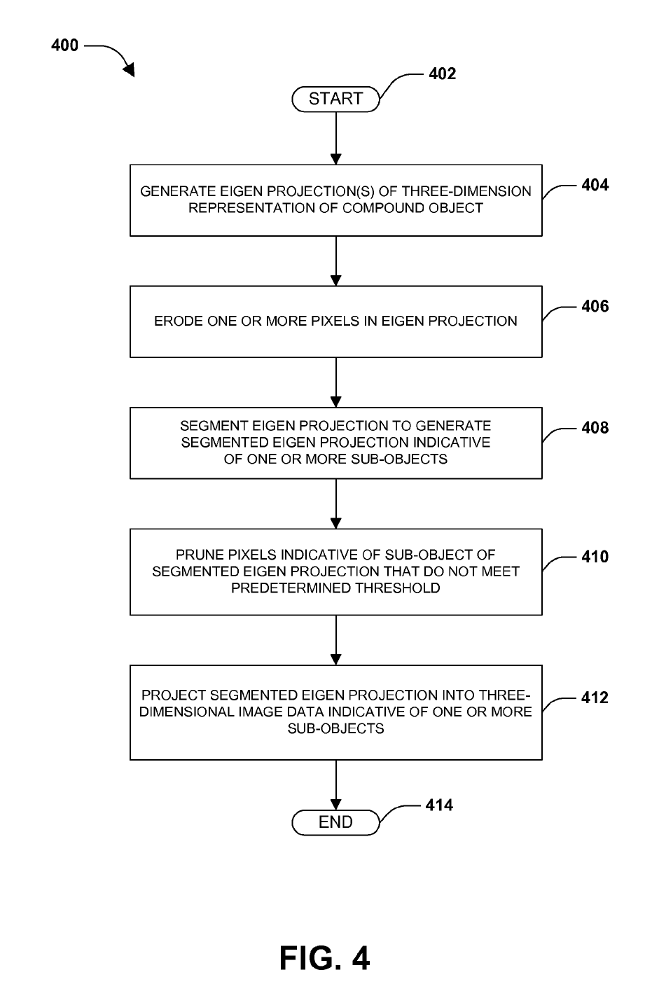

FIG. 4 is a flow chart diagram of an example method 400. Such an example method 400 may be useful for splitting a potential three-dimensional compound object, for example. The method begins at 402 and comprises projecting three-dimensional image data indicative of a potential compound object (e.g., a three-dimensional representation of the potential compound object) under examination to generate a two-dimensional Eigen projection representative of the potential compound object at 404. That is, principal axes of the object, or rather the three-dimensional representation of the object, are identified, and the three-dimensional representation is projected onto at least one plane normal to a principal axis of the object using analytical and/or iterative techniques known to those skilled in the art. It will be appreciated that identifying Eigen vectors in an object or a three-dimensional representation of the object and/or projecting data along the Eigen vectors is known to those skilled in the art, and thus is not described in detail herein (e.g., as standard techniques for identifying principal axis/Eigen vectors are known). Moreover, it will be appreciated to those skilled in the art that by projecting along the Eigen vectors, a reduced (e.g., minimum) projection of the object may be achieved, for example (e.g., depending upon which principal axis the projection is normal to).

Moreover, it one embodiment, during the projection of the three-dimensional image data, a correspondence between the three-dimensional image data and the two-dimensional Eigen projection is recorded. That is, the image data is mapped from three-dimensional image space to a two-dimensional Eigen projection and voxel data of one or more voxels of the three-dimensional image space is recorded as being associated with a pixel of the two-dimensional Eigen projection.

It will be appreciated that before the three-dimensional image data is projected into one or more two-dimensional Eigen projections, it may be useful to first identify whether an object is likely to be a potential compound object. In this way, the acts herein described may not be performed unless it is probable that an identified object (e.g., as identified by the object and feature extractor 122 in FIG. 1) is a compound object. In one example, the probability that an object is a potential compound object is determined by calculating the average density and/or atomic number (e.g., if the examination apparatus is a multi-energy system) and a standard deviation. If the standard deviation is above a predefined threshold, the object may be considered a potential compound object and thus the acts herein described may be performed to split the potential compound object into one or more sub-objects.

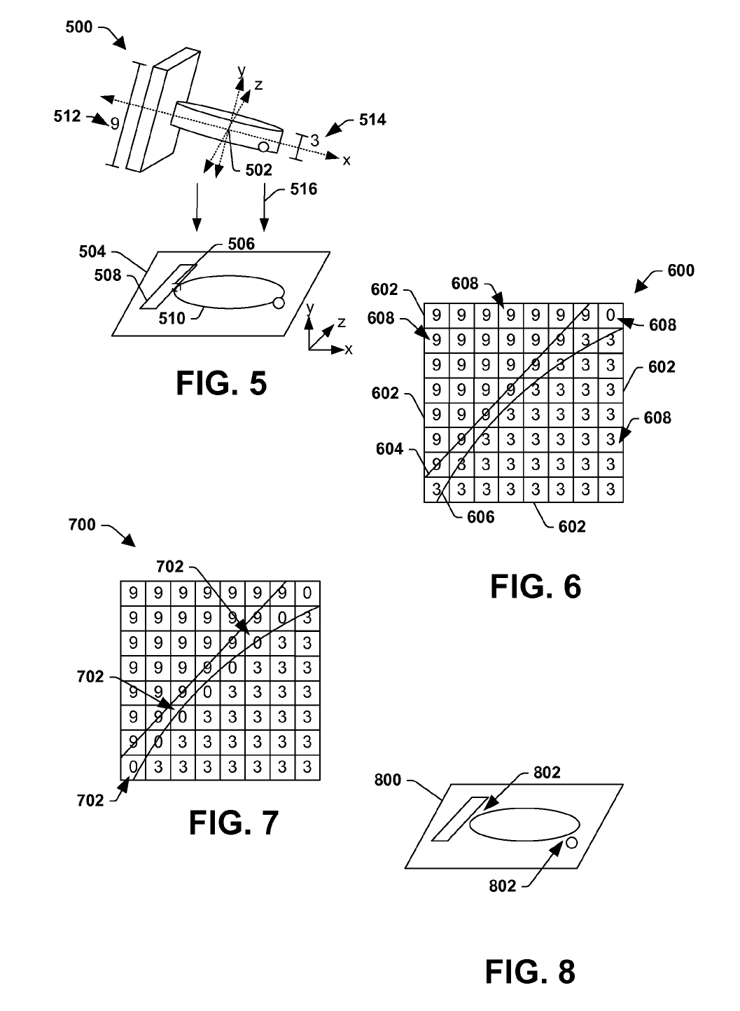

FIG. 5 is a graphical representation of three-dimensional image data of a compound object 500 being projected 516 onto a two-dimensional Eigen projection 504. As illustrated, the projection 504 does not necessarily correspond to the orientation of the object 500. That is, an Eigen projection 504 is independent of the orientation of the object 500 as it was examined (e.g., the Eigen projection 504 does not change regardless of whether the object 500 is rotated and/or translated). Rather, the principal axes 502 of the object 500, or of the three-dimensional representation of the compound object, are determined and the image data is projected normal to one of the three principal axis (e.g., but multiple Eigen projections may be generated, respective projections normal to a different principal axis). For example, in the illustrated example, the image data is projected normal to the principal y-axis, such that the plane of the Eigen projection is parallel to a plane in which the principal x- and z-axes lie. It will be appreciated that this is different than a projection generated in Euclidean space, where the projection would change as the object is rotated relative an examination surface of the x-ray imaging system.

Because a dimension is lost when projecting from three-dimensional space to two-dimensional space, pixels of the two-dimensional Eigen projection are assigned a value (e.g., hereinafter referred to as a “pixel value”) based upon the number of voxels represented by the pixel. For example, if the principal y-dimension of the image data is lost during the projection, the pixel is assigned a value corresponding to the number of voxels in the principal y-dimension that the pixel represents, or rather the number of non-zero voxels that lay along the principal y-dimension.

FIG. 6 illustrates an enlargement 600 of a portion of the two-dimensional Eigen projection 506 in FIG. 5. The squares 602 represent pixels in the two-dimensional Eigen projection. Pixels above a diagonal line 604 (e.g., an edge of a rectangular portion 508 of the object 500 in FIG. 5) are representative of the rectangular portion 508. Pixels below an arched line 606 (e.g., an edge of an oval portion 510 of the object 500 in FIG. 5) are representative of the oval portion 510 in FIG. 5. As illustrated, respective pixels are assigned a pixel value 608 (e.g., a number) corresponding to the number of voxels represented by the pixel. For example, pixels representative of the rectangular portion 508 have a pixel value of nine because the rectangular portion 508 was represented by nine voxels in the principal y-dimension 512 (at all principal x and z dimensions of the represented portion of the rectangle 508). Similarly pixels representative of the oval portion 510 have a pixel value of three because the oval portion 510 was represented by three voxels in the principal y-dimension 514 (at all principal x and z dimensions the represented portion of the oval 510). It will be appreciated that pixels that are representative of both the oval portion 510 and the rectangular portion 508 (e.g., pixels that are situated between the diagonal line 604 and the arched line 606) may be assigned a pixel value corresponding to the portion of the object represented by a larger number of voxels (e.g., the rectangle 508), for example.

Returning to FIG. 4, at 406 in the example method 400, the two-dimensional Eigen projection (e.g., 504 in FIG. 5) is eroded or rather one or more pixels in the Eigen projection are eroded. That is, connections between two or more objects (e.g., the rectangle 508 and the oval 510 in FIG. 5) are removed so that the objects are defined as a plurality of objects rather than a single, compound object (e.g., 500 in FIG. 5). Typically, eroding involves setting pixels identified with the connection to a value (e.g., zero) indicative of no object or indicative of background.

In one example, an adaptive erosion technique is used to erode the two-dimensional Eigen projection. That is, a determination of whether to erode one or more pixels is dynamic (e.g., the erosion characteristics are not constant) and is based upon characteristics of pixels neighboring the pixel being considered for erosion. That is, an erosion threshold for determining whether to erode a pixel or not to erode a pixel is based upon characteristics of neighboring pixels and the same erosion threshold may not be used for each pixel that is being considered for erosion. An adaptive erosion technique may be beneficial over other erosion techniques known to those skilled in the art to preserve portions of the object (e.g., 500 in FIG. 5) that are located towards the interior of the object, or rather sub-objects, and portions of the object that are strongly connected based on probability analysis (using a Markov random field model), for example. However, it will be appreciated that in other embodiments, a static erosion technique (e.g., where the erosion threshold is constant), may be applied.

As an example, the adaptive erosion technique used to determine whether to erode a first pixel may comprise comparing pixel values (e.g., 608 in FIG. 6) for pixels neighboring the first pixel to determine an erosion threshold for the first pixel. Once the erosion threshold for the first pixel has been determined, it may be compared to respective pixel values of the neighboring pixels. If a predetermined number of respective pixel values of neighboring pixels are below the erosion threshold, the first pixel may be eroded. These acts may be repeated to determine an erosion threshold for a second pixel and to determine whether to erode the second pixel, for example.

FIG. 7 illustrates an enlargement 700 (e.g., 600 in FIG. 6) of a portion of the two-dimensional Eigen projection 506 in FIG. 5 after the two-dimensional Eigen projection has been eroded. As illustrated, pixels were eroded if at least four neighboring (e.g., in this case adjacent) pixels did not exceed the erosion threshold (e.g., 5) for the pixel under consideration for erosion. The eroded pixels (e.g., 702) are represented by a pixel value of zero. The pixels that were not eroded maintained the pixel value that was assigned to them before the two-dimensional Eigen projection was eroded, for example.

FIG. 8 illustrates a two-dimensional Eigen projection 800 (e.g., 504 in FIG. 5) after erosion of one or more pixels. It will be appreciated that sub-objects of the compound object 500 have been defined and are no longer in contact with one another (e.g., there is space 802 between sub-objects). This may allow a two-dimensional segmentation component (e.g., 306 in FIG. 3) to more easily segment the compound object into sub-objects, for example.

Returning to FIG. 4, at 408 in the example method 400, the eroded Eigen projection (e.g., 800 in FIG. 8) is segmented to generate a two-dimensional, segmented Eigen projection indicative of one or more sub-objects. Segmentation generally involves binning (e.g., grouping) pixels representative of a sub-object together and/or labeling pixels to associate the pixels with a particular object. For example, a suitcase may have a plurality of objects (each object identified by a label in the three-dimensional image data). One object, identified by label “5” may be considered a potential compound object and thus image data of the potential compound object may be converted to an Eigen projection(s) and respective pixels may be identified by the label “5” (e.g., corresponding to the object being examined). After the Eigen projection is eroded, three sub-objects may be identified and the pixels may be relabeled (e.g., segmented). A first sub-object may be labeled “5,” a second sub-object may be labeled “6,” and a third sub-object may be relabeled “7,” for example. In this way, three sub-objects may be identified from a single potential compound object (e.g., which was originally labeled as “5” by the object and feature extractor 122 in FIG. 1).

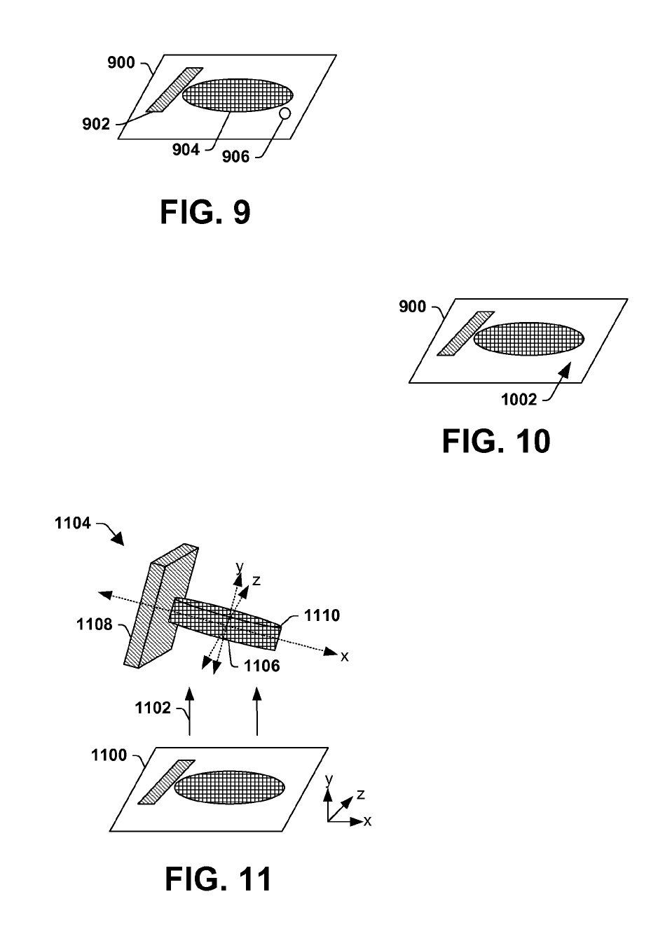

FIG. 9 illustrates a two-dimensional segmented, Eigen projection 900 indicative of three objects (e.g., similar to the initial Eigen projection 504 in FIG. 5). Pixels indicative of a rectangular sub-object 902 (e.g., 508 in FIG. 5) are labeled with a first label, pixels indicative of an oval sub-object 904 (e.g., 510 in FIG. 5) are labeled with a second label, and pixels indicative of a circular sub-object 906 are labeled with a third label. Stated differently, pixels of the two-dimensional Eigen projection 500 that were originally indicative of a single potential compound object 500 are now indicative of three sub-objects. It will be appreciated that the shading in FIG. 9 is merely intended to represent the recognition of sub-objects, rather than a single compound object, and is not intended to represent coloring or shading of the Eigen projection 900.

At 410 in the example method 400, pixels indicative of sub-objects of the two-dimensional segmented projection that do not meet predetermined criteria are pruned (e.g., the pixels are set to a background value or to zero). The predetermined criteria may include a pixel count for the sub-object (e.g., a number of pixels representative of the sub-object), the mass of the sub-object, and/or other criteria that would help determine whether the sub-object is valuable to the examination and therefore should not be pruned. For example, pixels that are indicative of a sub-object that is unlikely to be a threat because of the size of the sub-object may be removed so that resources are not consumed back-projecting the pixels into three-dimensional space. In FIG. 10, the circular sub-object 906 of the segmented Eigen projection 900 illustrated in FIG. 9 is pruned 1002 because the number of pixels representing the circular sub-object 906 were too few to indicate that the sub-object was a security threat, for example.

At 412 in the example method 400, the two-dimensional segmented Eigen projection is projected into three-dimensional image data (e.g., a three-dimensional representation) indicative of the sub-objects. Such projection may occur utilizing the correspondence (e.g., 351 in FIG. 3) between the three-dimensional image data and the two-dimensional Eigen projection, for example. In one example, this comprises relabeling voxels of the three-dimensional image data (e.g., 156 in FIG. 1) indicative of the potential compound object according to the labels of corresponding pixels in the segmented Eigen projection (e.g., 900 in FIG. 10). For example, if voxels of the potential compound object were labeled as associated with object “5” in a suitcase, the voxels may be relabeled such that some of the voxels are indicative of a rectangular object (labeled “5”) and some of the voxels are indicative of an oval object (labeled “6”). In this way, data that is determined to be indicative of a compound object it split into a plurality sub-objects.

FIG. 11 provides a graphical representation of the two-dimensional segmented, Eigen projection 1100 (e.g., 900 in FIG. 10) being back-projected 1102 along Eigen vectors 1106 into three-dimensional image data indicative of one or more sub-objects 1104. As illustrated by the shading, the rectangular object 1108 is recognized as a first object and the oval object 1110 is recognized as a second object (e.g., the objects are no longer recognized as parts of a compound object 500). It will be appreciated that the small circular object illustrated in the potential compound object 500 in FIG. 5 is not illustrated in the three-dimensional image data indicative of one or more sub-objects 1104 because pixels representative of the small circular object (e.g., in the Eigen projection 900 in FIGS. 9-10) where eroded (e.g., causing voxels in the three-dimensional image data to be relabeled as background and/or to be discarded), for example.

It will be appreciated that in one embodiment, the three-dimensional image data indicative of the sub-objects may be segmented to further segment the sub-objects and/or to identify one or more secondary sub-objects. Stated differently, after an initial segmentation (e.g., to identify one or more sub-objects) image data representative of one or more of the sub-objects may be further segmented to identify one or more sub-objects of the identified sub-object (e.g., using techniques similar to those described above or other compound splitting techniques known to those skilled in the art). For example, in one embodiment, the image data indicative of one or more sub-objects may be projected normal to a different one of the principal axis than the initial projection (e.g., as illustrated in FIG. 5). In this way, sub-objects that overlap in the dimension that was collapsed in the initial projection (e.g., such that in the initial Eigen projection there is no discernable border between the two objects because the gap between the two objects resided in the collapsed dimension), can be identified and the sub-object can be further segmented, for example.

Returning to FIG. 4, the method 400 ends at 414.

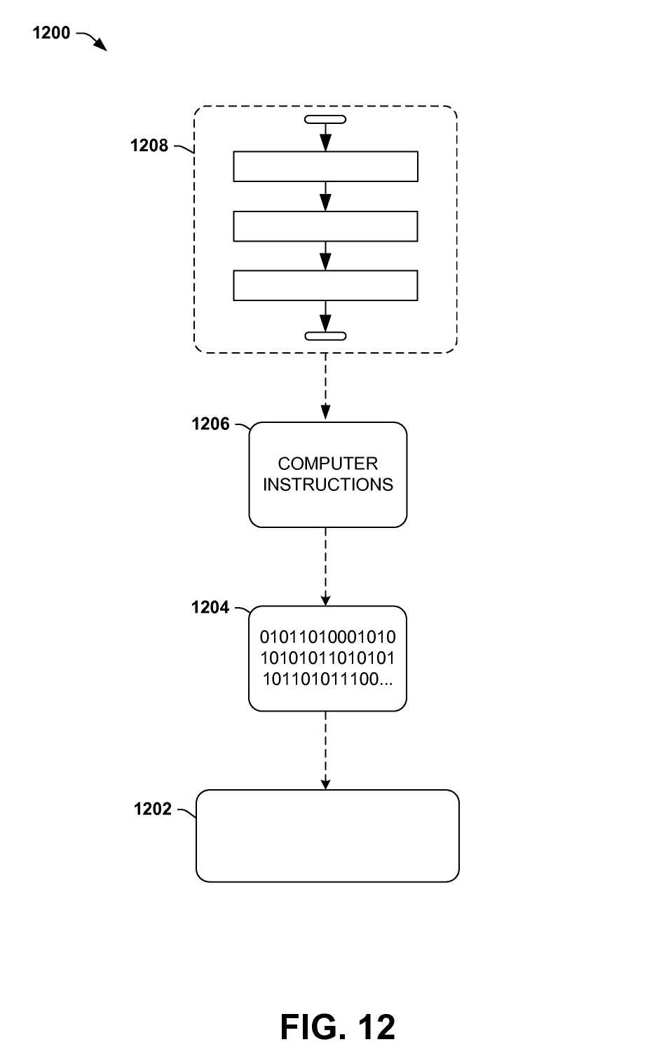

Still another embodiment involves a computer-readable medium comprising processor-executable instructions configured to implement one or more of the techniques presented herein. An example computer-readable medium that may be devised in these ways is illustrated in FIG. 12, wherein the implementation 1200 comprises a computer-readable medium 1202 (e.g., a CD-R, DVD-R, a platter of a hard disk drive, or other computer-readable storage device), on which is encoded computer-readable data 1204. This computer-readable data 1204 in turn comprises a set of computer instructions 1206 configured to operate according to one or more of the principles set forth herein. In one such embodiment 1200, the processor-executable instructions 1206 may be configured to perform a method 1208, such as the example method 400 of FIG. 4, for example. In another such embodiment, the processor-executable instructions 1206 may be configured to implement a system, such as at least some of the exemplary examination apparatus 100 of FIG. 1, for example. Many such computer-readable media may be devised by those of ordinary skill in the art that are configured to operate in accordance with one or more of the techniques presented herein.

Moreover, the words “example” and/or “exemplary” are used herein to mean serving as an example, instance, or illustration. Any aspect, design, etc. described herein as “example” and/or “exemplary” is not necessarily to be construed as advantageous over other aspects, designs, etc. Rather, use of these terms is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B or the like generally means A or B or both A and B.

Although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

1. A method for separating a three-dimensional representation of a compound object into sub-objects, comprising:
using an Eigen projection representative of the compound object and generated from the three-dimensional representation of the compound object generated by a radiation examination to yield a three-dimensional representation indicative of one or more sub-objects of the compound object.

2. The method of claim 1, comprising generating the Eigen projection representative of the compound object by projecting the three-dimensional representation of the compound object onto a plane normal to a principal axis of the three-dimensional representation.

3. The method of claim 1, comprising eroding one or more pixels in the Eigen projection to generate an eroded Eigen projection.

4. The method of claim 3, comprising segmenting the eroded Eigen projection to generate a segmented Eigen projection, where a group of pixels in the segmented Eigen projection is indicative of a first sub-object of the one or more sub-objects.

5. The method of claim 4, comprising associating respective pixels in the segmented Eigen projection with one or more voxels in the three-dimensional representation

6. The method of claim 4, the segmenting comprising:
labeling a first group of pixels in the eroded Eigen projection with a first label identifying the first sub-object; and
labeling a second group of pixels in the eroded Eigen projection with a second label identifying a second sub-object of the one or more sub-objects.

7. The method of claim 6, comprising relabeling a first set of voxels in the three-dimensional representation of the compound object with the first label and a second set of voxels in the three-dimensional representation of the compound object with the second label.

8. The method of claim 4, comprising back-projecting the segmented Eigen projection into three-dimensional space.

9. The method of claim 3, the eroding comprising eroding one or more pixels in the Eigen projection that meet an erosion threshold.

10. The method of claim 9, where the erosion threshold for a first pixel in the Eigen projection is a function of a pixel value of a pixel neighboring the first pixel.

11. The method of claim 3, the eroding comprising:
determining an erosion threshold for a first pixel in the Eigen projection based upon one or more pixels neighboring the first pixel;
and
eroding the first pixel if pixel values for a determined number of pixels neighboring the first pixel meet the erosion threshold.

12. A system for compound object separation in image data, comprising:
an Eigen projection component configured to generate an Eigen projection from a three-dimensional representation of a compound object;
a segmentation component configured to generate a segmented Eigen projection of the compound object by segmenting pixels of the Eigen projection representative of a first sub-object of the compound object and pixels of the Eigen projection representative of a second sub-object of the compound object; and
a back-projection component configured to relabel a voxel of the three-dimensional representation of the compound object according to a label assigned to a corresponding pixel in the segmented Eigen projection to generate a three-dimensional representation indicative of one or more sub-objects of the compound object.

13. The system of claim 12, the Eigen projection component configured to generate the Eigen projection by projecting the three-dimensional representation of the compound object onto a plane normal to a principal axis of the three-dimensional representation of the compound object.

14. The system of claim 12, comprising a projection erosion component configured to generate an eroded Eigen projection from the Eigen projection by eroding one or more pixels in the Eigen projection, the projection erosion component configured to determine whether to erode a first pixel by:
determining an erosion threshold for the first pixel based upon one or more pixels neighboring the first pixel;
and
eroding the first pixel if pixel values for a predetermined number of pixels neighboring the first pixel meet the erosion threshold,
where the segmentation component is configured to generate the segmented Eigen projection from the eroded Eigen projection.

15. The system of claim 12, the segmentation component configured to label a first group of pixels of the Eigen projection with a first label and a second group of pixels of the Eigen projection with a second label, where the first label corresponds to a first sub-object of the one or more sub-objects and the second label corresponds to a second sub-object of the one or more sub-objects.

16. The system of claim 12, the back-projection component configured to project the segmented Eigen projection to generate the three-dimensional representation indicative of the one or more sub-objects.

17. A computer readable storage device comprising computer executable instructions that when executed perform a method, comprising:
generating an Eigen projection of three-dimensional image data indicative of a compound object by projecting the three-dimensional image data onto a plane normal to a principal axis of the three-dimensional image data;
eroding the Eigen projection using an adaptive erosion technique to generate an eroded Eigen projection;
segmenting the eroded Eigen projection to generate a segmented Eigen projection indicative of one or more sub-objects of the compound object; and
projecting the segmented Eigen projection into three-dimensional image data indicative of the one or more sub-objects.

18. The computer readable storage device of claim 17, the adaptive erosion technique comprising:
determining an erosion threshold for a first pixel based upon one or more pixels neighboring the first pixel;
and
eroding the first pixel if pixel values for a predetermined number of pixels neighboring the first pixel meet the erosion threshold.

19. The computer readable storage device of claim 18, comprising summing a number of non-empty voxels along an Eigen vector direction for an Eigen projection to determine a pixel value for a pixel neighboring the first pixel.

20. The computer readable storage device of claim 17, the three-dimensional image data indicative of the compound object acquired from a radiation examination of the compound object.

21. (canceled)
